(19) United States
(12) Patent Application Publication
(10) Pub. No.: US 2005/0031243 A1
(43) Pub. Date: Feb. 10, 2005

(54) Bearing systems

(76) Inventor: David K. Yew, Cheshire (GB)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/493,733

(22) PCT Filed: Nov. 22, 2002
(86) PCT No.: PCT/GB02/05271

(30) Foreign Application Priority Data
Nov. 22, 2001 (GB) 0127974.4

(51) Int. Cl. F16C 41/00

(52) U.S. Cl. 384/624

(57) ABSTRACT

A bearing system includes a barrier, a bearing unit housing, and a bearing unit for conveying a drive through the barrier. The bearing unit housing defines an opening through the barrier extending between the first and second sides of the barrier. The bearing unit housing extends along an axis and includes a contact portion extending parallel to the axis which contacts a contact portion of the bearing unit extending parallel to the axis. The length of the contact portion of the bearing unit housing exceeds the distance along the axis between the part of the contact portion of the bearing unit nearest the first side of the barrier and the part of the contact portion of a replacement bearing unit nearest the second side of the barrier. The invention offers particular advantages in maintaining containment provided by the barrier during barrier replacement.

This invention concerns improvements in and relating to bearing systems, particularly, but not exclusively, in relation to bearing units within such systems that require occasional replacement whilst maintaining containment of an associated environment.

Many situations require motive power to be delivered into a hazardous environment whilst maintaining containment for the environment. Placing the motive power source in the hazardous environment is undesirable as it is exposed to the hazardous environment and is not easily accessible as a result. It is possible to provide the motive power source outside the hazardous environment, but then suitable means must be provided to bring the power into the environment whilst maintaining containment. In such situations the transit between the hazardous environment and surrounding environment a bearing unit is often provided. Due to routine wear and tear the bearing unit may need replacement on occasions and this causes a potential break in containment whilst the replacement is effected.

The present invention has amongst its aims the replacement of bearing units whilst maintaining containment for a hazardous environment.

According to a first aspect of the invention we provide a bearing system including a barrier, a bearing unit housing and a bearing unit for conveying a drive through the barrier, wherein the bearing unit housing defines an opening through the barrier extending between first and second sides of the barrier, the bearing unit housing extends along an axis, the bearing unit housing includes a contact portion extending parallel to the axis which contacts a contact portion of the bearing unit extending parallel to the axis, the length of the contact portion of the bearing unit housing exceeds the distance along the axis between the part of the contact portion of the bearing unit nearest the first side of the barrier and the part of the contact portion of a replacement bearing unit nearest the second side of the barrier.

The first aspect may further provide that the length of the contact portion of the bearing housing exceeds the distance between the leading part of the contact portion of the bearing unit and the part of the bearing unit which extends furthest from the first side of the containment barrier and is integral with the bearing unit.

According to a second aspect of the invention we provide a bearing system including a barrier, a bearing unit housing and a bearing unit for conveying a drive through the barrier, wherein the bearing unit housing defines an opening through the barrier extending between first and second sides of the barrier, the bearing unit housing extends along an axis, the bearing unit housing includes a contact portion extending parallel to the axis which contacts a contact portion of the bearing unit extending parallel to the axis, and wherein the length of the contact portion of the bearing housing exceeds the distance between the leading part of the contact portion of the bearing unit and the part of the bearing unit which extends furthest from the first side of the barrier and is integral with the bearing unit.

The second aspect may further provide that the length of the contact portion of the bearing unit housing exceeds the distance along the axis between the part of the contact portion of the bearing unit nearest the first side of the barrier and the part of the contact portion of a replacement bearing unit nearest the second side of the barrier.

The first and/or second aspects of the invention may provide one or more of the following features, options or possibilities.

The bearing system may include one or more of a motor, one or more drive shafts connecting the motor to the bearing unit, one or more drive shafts connecting the bearing unit to the equipment to be driven. In particular a first drive shaft, connected directly or indirectly, to the motor may be connected to a second drive shaft connected to the bearing unit or to the drive shaft of the bearing unit, directly by means of a coupling and preferably a flexible coupling. In particular the bearing unit may be connected to the equipment to be driven, directly or indirectly, using a further drive shaft having at both ends releasable couplings, particularly couplings of the two half type. It is particularly preferred that the drive shaft of the bearing unit is connected to the further drive shaft using such two half couplings. Preferably the motor is provided to the first side of the barrier and the equipment to be driven is provided to the second side of the barrier. Preferably the further drive shaft is longer than the drive shaft of the bearing unit.

The barrier may be of metal or concrete. The barrier particularly provides physical containment for radioactive material, such as plutonium oxides or uranium oxides. The barrier may provide radiological shielding. Preferably the hazardous environment is on the second side of the barrier. Preferably an ambient environment is on the first side of the barrier.

Preferably the barrier is provided with an aperture which is fully surrounded by the bearing unit housing. The bearing unit housing may be releasably fastened to the barrier. Preferably the releasable fastenings are bolts. Preferably the bolts are introduced from the first side of the barrier. Preferably the holes receiving the bolts do not penetrate from the first to the second side of the barrier. The bearing unit housing may be retained on the barrier by fasteners engaging a flange projecting from the bearing unit housing, particularly a flange extending substantially perpendicular to the axis of the bearing system.

Preferably the bearing unit housing includes a body portion. The flanges may be connected to the body portion. Preferably the body portion extends generally along the axis. It is particularly preferred that the body portion defines a cylindrical internal space, most preferably a right cylinder with an axis corresponding to the axis of the system. Preferably the bearing unit housing is provided with an aperture extending from the first to the second side of the barrier which is of circular cross section and preferably of constant radius throughout at least the mid 90% of its length. An increased radius may be provided for a portion of the bearing unit housing closest to the first and/or second sides of the barrier. The increased radius portion may be chamfered or of truncated conical shape. Preferably the external configuration of the body portion of the bearing unit housing is cylindrical.

Preferably the bearing unit is in sliding contact with the internal surface of the bearing unit housing. Sliding contact around the entire periphery for at least a portion of the bearing unit is preferably provided. Preferably this portion extends for at least 80% and more preferably at least 90% of the axial length of the bearing unit. Preferably the bearing unit has a cylindrical external profile. Preferably the bearing unit has a constant radius throughout at least 80% and more preferably at least 90% of its axial length. The bearing unit may have a reduced radius towards the ends nearest the first and/or second sides of the barrier.

The bearing unit may include a cylindrical body portion to which an end plate is fastened at each end. The end plates are preferably fastened by bolts.

The bearing unit preferably accommodates a centrally provided drive shaft. Preferably the drive shaft is supported by a pair of bearings. Preferably one bearing is provided towards one end of the bearing unit, and the other bearing is provided towards the other end of the bearing unit. Preferably one or more seals are provided between the first side and the bearing closest thereto and/or between the second side and the bearing closest thereto. O-rings and other seals could be used for this purpose.

Preferably the drive shaft extending through the bearing unit is provided with a locking nut to maintain it in position.

Preferably the drive shaft extending through the bearing unit is provided with a male portion at one end, and a female portion at the other end. The male portion may be provided by a portion of the drive shaft of greater cross-section compared with the female portion. Preferably the male portion has a greater external radius than the female portion. Preferably the male portion is provided with a recess adapted to receive and cooperate with at least a part of the female portion.

Preferably the bearing unit housing is provided with an end plate on the first side of the barrier. Preferably the end plate engages the body of the bearing unit housing by means of one or more releasable fasteners. Preferably one or more releasable fasteners pass through the end plate and engage the bearing unit. Preferably the end plate is provided with an aperture through which the drive, particularly the drive shaft of the bearing unit passes.

One or more of the drive shafts and/or couplings on the second side of the barrier may be provided within an enclosure, such as a guard.

Preferably the axis of the bearing unit housing corresponds to the axis of the drive through the bearing unit.

Preferably the contact portion of the bearing unit housing extends around the entire profile thereof for at least a part of the length thereof. Preferably the contact portion of the bearing unit housing extends for at least 75% and more preferably 80% and ideally 90% of the length of the bearing unit housing along the length of the axis.

Preferably the contact portion of the bearing unit extends around the entire circumference thereof for at least a part of the length thereof. Preferably the contact portion of the bearing unit extends for at least 75% and more preferably 80% and ideally 90% of the length of the bearing unit along the length of the axis.

The part of the bearing unit which extends furthest from the first side may be the end of the integral drive shaft thereof. Preferably this end is provided with a female portion. Preferably the overall length of the bearing unit along the axis is less than the overall distance along the axis between the barrier surface on the second side of the barrier and the end nearest the second side of the barrier of the drive shaft adjacent to the drive shaft connected to the bearing unit. More preferably the overall length of the bearing unit is less than the distance between the second side of the barrier and the part of the coupling retained on the drive shaft adjacent to the drive shaft connected to the bearing unit.

Preferably the bearing unit incorporates a seal for life bearings. Preferably the bearing unit is housed in stainless steel. The bearing unit housing may be provided with one or more mounts for accelerometers.

Preferably the end surface of the bearing unit closest to the second side of the barrier in use is flush with the surrounding part of the bearing unit housing and/or surface of the barrier.

According to a third aspect of the invention we provide a method of replacing a bearing unit in a bearing system, the bearing system including a barrier, a bearing unit housing and a bearing unit for conveying a drive through the barrier, the bearing unit housing defining an opening through the barrier extending between first and second sides of the barrier, the bearing unit housing extending along an axis, the bearing unit housing including a contact portion extending parallel to the axis which contacts a contact portion of the bearing unit extending parallel to the axis, the method including
disconnecting the bearing unit in the bearing system from the drive to and from the bearing unit,
introducing a replacement bearing unit into abutment with the bearing unit and advancing the replacement bearing unit into the bearing unit housing from the first side of the barrier and displacing the bearing unit towards the second side of the barrier
during displacement, contact being maintained between at least a part of a contact portion of the bearing unit and at least a part of a contact portion of the bearing unit housing until contact occurs between at least a part of a contact portion of the replacement bearing unit and at least a part of a contact portion of the bearing unit and
removing the bearing unit from the bearing unit housing on the second side of the barrier and connecting the bearing unit to the drives to and from the bearing unit.

The third aspect of the invention may include one or more of the features, options or possibilities set out elsewhere in this document including those set out above in relation to the first and second aspects of the invention.

Preferably the bearing unit is replaced by an equivalent replacement bearing unit.

Preferably the bearing system is electrically isolated prior to working thereon.

The bearing unit may be disconnected from the drives to the bearing unit by removing the flexible coupling and/or drive shaft linking the flexible coupling to the bearing unit and/or the drive shaft linking the flexible coupling to the motor and/or by moving the motor.

The drive from the bearing unit may be disconnected by removing the drive shaft adjacent to the drive shaft of the bearing unit, potentially together with the coupling or a portion thereof connecting those drive shafts together and potentially and alternatively together with the removal of at least part of the coupling connecting that drive shaft to the subsequent drive shaft of the bearing system.

Preferably the replacement bearing unit is introduced along the axis of the bearing unit housing. Preferably the part of the drive shaft of the replacement bearing unit closest to the first side of the barrier engages with the part of the bearing unit furthest from the second side of the barrier and ideally with the drive shaft thereof. Preferably the replacement bearing unit is provided with one of a male or female part closest to the first side of the barrier and the bearing unit is provided with the converse of a male or female portion of the part thereof furthest from the second side of the barrier. Preferably introduction of the replacement bearing unit brings the drive shaft thereof into abutment with the drive shaft of the bearing unit. The least part of the contact portion of the bearing unit maintained in contact with the contact portion of the bearing unit housing may be 20% or more of the maximum possible contact portion of the bearing unit when the contact portion of the replacement bearing unit first contacts the contact portion of the bearing unit.

Preferably the replacement bearing unit is introduced along the axis of the bearing unit housing. Preferably the part of the drive shaft of the replacement bearing unit closest to the first side of the barrier engages with the part of the bearing unit furthest from the second side of the barrier and ideally with the drive shaft thereof. Preferably the replacement bearing unit is provided with one of a male or female part closest to the first side of the barrier and the bearing unit is provided with the converse of a male or female portion of the part thereof furthest from the second side of the barrier. Preferably introduction of the replacement bearing unit brings the drive shaft thereof into abutment with the drive shaft of the bearing unit. The least part of the contact portion of the bearing unit maintained in contact with the contact portion of the bearing unit housing may be 20% or more of the maximum possible contact portion of the bearing unit when the contact portion of the replacement bearing unit first contacts the contact portion of the bearing unit.

Preferably the bearing unit is removed along the axis of the bearing unit housing. The at least part of the contact portion of the replacement bearing unit in contact with the contact portion of the bearing unit housing may be 20% or more of the maximum possible contact portion of the bearing unit when the contact portion of the bearing unit breaks contact with the contact portion of the bearing unit.

The bearing unit may be removed from the bearing unit housing on the second side of the barrier by a manipulator or other operative component on the second side of the barrier. The manipulator or operative component is preferably used to remove and connect the drive shaft and/or coupling on the second side of the barrier. The bearing unit may be removed from between the second surface of the barrier and the drive shaft adjacent to the drive shaft connected, in use, to the bearing unit.

The bearing unit may be retained within the second side of the barrier or may be removed therefrom by a further opening in the barrier provided elsewhere.

Embodiments of the invention will now be described, by way of example only, with reference to the accompanying drawings in which:

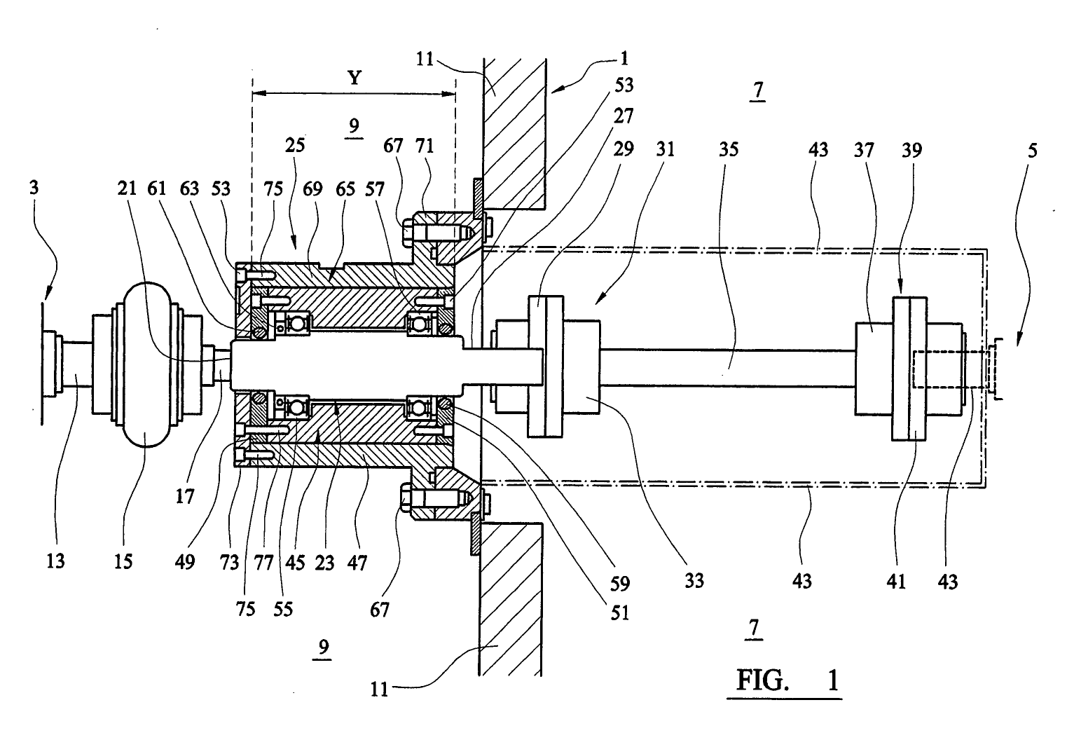

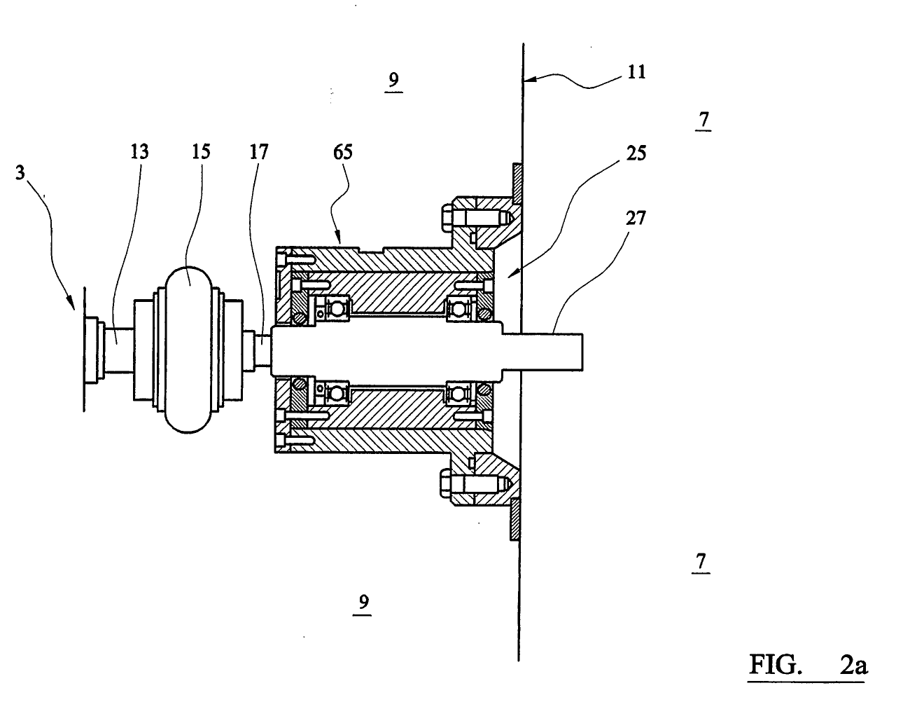

FIG. 1 illustrates a bearing system in assembled configuration;

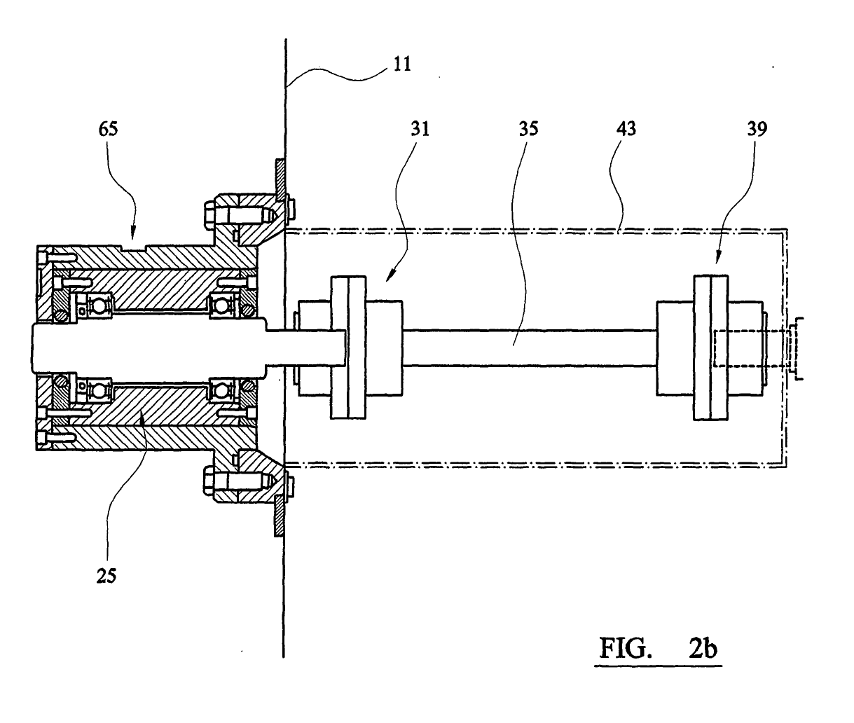

FIG. 2a illustrates an initial configuration during replacement of a bearing unit in the bearing system;

FIG. 2b illustrates a subsequent configuration during the replacement of the bearing unit in the bearing system; and

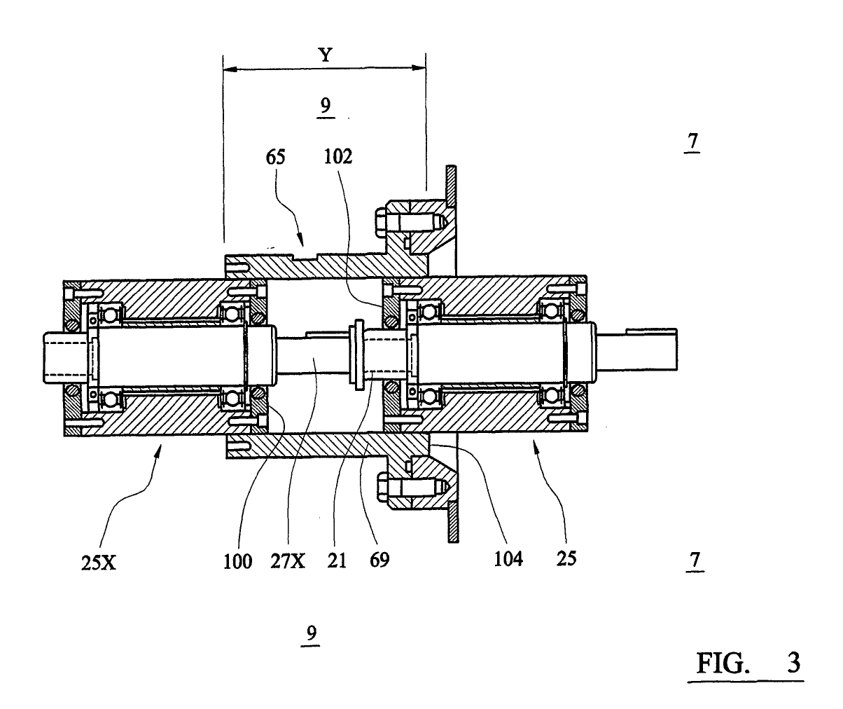

FIG. 3 illustrates a still subsequent configuration illustrating initial introduction of the replacement bearing unit into the bearing system.

FIG. 1 illustrates one example of a bearing system 1 designed to convey motive power from a power source, such as a motor 3, to equipment 5 needing such power. The equipment 5 is within a hazardous environment 7 which is separated from the external environment 9 by containment barrier 11.

The rotation of motor drive shaft 13 passes through flexible coupling 15 to first shaft 17. The first shaft 17 is provided with a reduced diameter male portion 19 which cooperates with female portion 21 of second drive shaft 23. The drive shaft 23 passes through the bearing unit 25 and ends at male portion 27. The male portion 27 is connected to a first half 29 of a coupler 31, the second half 33 of the coupler 31 connecting to a third drive shaft 35. The third drive shaft 35 connects to a first half 37 of a further coupler 39, with the second half 41 of the further coupler 39 connecting to an equipment drive shaft 43 which links directly or indirectly to the equipment 5. The coupler 31, further coupler 39, their linking third drive shaft 35 and the projecting male portion 27 of the second drive shaft 23 are enclosed within guard 43.

The bearing unit 25 is in the general form of a cylindrical component 45 defined by a cylinder 47, first end plate 49 and second end plate 51. The end plates 49, 51 are connected to the cylinder 47 by bolts 53. The bearings 55, 57 are provided on the cylinder 47 and are lifetime sealed by dust and oil seals 59, 61 to avoid any loss or contamination of the lubricant within the assembly 25. A locknut 63 is provided to apply a force onto the bearing 55.

The bearing unit 25 is mounted on the containment barrier 11 by a housing 65. The housing 65 is mounted to the containment barrier 11 by means of bolts 67 which do not penetrate the containment barrier 11. The housing 65 is formed by a cylinder 69, of corresponding internal diameter to the outside diameter of the cylinder 47, together with a radial extension 71 which receives the bolts 67. An end plate 73 is fastened to the cylinder 69 by bolts 75 and to the bearing unit 25 by bolts 77 to retain the bearing unit 25 in the desired position.

In this configuration power can be conveyed from the safe environment 9 to the hazardous environment 7, but with a full seal between the two.

If the bearing unit 25 develops a problem, or more usually, reaches its scheduled replacement time, then the following sequence can be used to replace the bearing unit 25 whilst maintaining the seal.

As an initial step in the replacement method the power to the bearing system 1 is isolated to allow safe working on it.

As one step in the method, the guard 43 is then removed using a manipulator within the hazardous environment and placed to one side. The half 33 of coupler 31 is then detached from half 29 and half 37 of coupler 39 is then detached from half 41 to allow the removal of the drive shaft 35. This drive shaft 35 is then placed to one side within the environment 7. The longer length of the drive shaft 35 compared with the length of the bearing unit 25 means that the drive shaft 35 removal gives sufficient space to remove the bearing unit by displacing it into the environment 7. The remaining half 29 of the coupler 31 is then removed and placed to one side also. The result of this step is shown in FIG. 2a.

Following or previous to this step the flexible coupling 15 is removed. This may be accompanied by removal of the one or more of the drive shafts 13, 17 or motor 3 to allow room for the replacement bearing unit 25X to be introduced. Once this step is completed the end plate 73 is removed following release of the bolts 75 and 77. The end plate 73 is put to one side in environment 9. The result of this step is shown in FIG. 2b.

In this state the seal is maintained but the bearing unit 25 is free to move in the housing 65.

As illustrated in FIG. 3, the new bearing unit 25X can now be brought into position in line with the existing bearing unit 25 and the housing 65. The new bearing unit 25X has a drive shaft 27X mounted on it which has a male end portion so that it cooperates with the female portion 21 of the drive shaft on the bearing unit 25. Advancing the bearing unit 25X from the environment 9 into the housing 65 pushes the bearing unit 25 into the hazardous environment 7. The leading edge 100 of the bearing unit 25X has a reduced diameter compared with the internal diameter of the housing 65 to assist insertion. The axial extent Y of the housing 65 is such that the leading edge 100 of the bearing unit 25X enters the cylinder 69 before the trailing edge 102 of the bearing unit 25 enter the environment 7; indeed, as is shown a significant overlap exists. Eventually continued advancement of the bearing unit 25X pushes the bearing unit 25 so far into the environment 7 that its trailing edge 102 comes clear of the housing 65. At this time the manipulator within the environment 9 is used to move the bearing unit 25 to one side, its useful life having finished. The trailing edge 102 of the bearing unit 25 has a reduced diameter compared with the internal diameter of the housing 65 to assist removal. The bearing unit 25 can be removed from the hazardous environment 7 using contaminated item removal procedures, if desired, or left there until the environment and its contents are decommissioned. With the bearing unit 25 removed, the bearing unit 25X can then be positioned correctly, with the leading edge 100 flush with the internal surface 104, within the housing 65 and the bearing system 1 can be reassembled.

Reassembly involves attaching the back plate 73, bolts 75, 77, flexible coupling 15 (and possibly accompanying drive shafts 13, 17 and/or motor 3), coupling half 29, drive shaft 35 and accompanying coupling halves 33 and 37, before the guard 43 is repositioned and fastened. The bearing system 1 is then ready for further use, but the integrity of the seal between the hazardous environment 7 and safe environment 9 is maintained throughout.

1. A system comprising: a barrier, a bearing unit housing and a bearing unit for conveying a drive through the barrier, wherein the bearing unit housing defines an opening through the barrier extending between first and second sides of the barrier, the bearing unit housing extends along an axis, the bearing unit housing includes a contact portion extending parallel to the axis which contacts a contact portion of the bearing unit extending parallel to the axis, the length of the contact portion of the bearing unit housing exceeds the distance along the axis between the part of the contact portion of the bearing unit nearest the first side of the barrier and the part of the contact portion of a replacement bearing unit nearest the second side of the barrier.

2. A system according to claim 1 in which the length of the contact portion of the bearing housing exceeds the distance between the leading part of the contact portion of the bearing unit and the part of the bearing unit which extends furthest from the first side of the containment barrier and is integral with the bearing unit.

3. A bearing system, comprising: a barrier, a bearing unit housing and a bearing unit for conveying a drive through the barrier, wherein the bearing unit housing defines an opening through the barrier extending between first and second sides of the barrier, the bearing unit housing extends along an axis, the bearing unit housing includes a contact portion extending parallel to the axis which contacts a contact portion of the bearing unit extending parallel to the axis, and wherein the length of the contact portion of the bearing unit housing exceeds the distance between the leading part of the contact portion of the bearing unit and the part of the bearing unit which extends furthest from the first side of the barrier and is integral with the bearing unit.

4. A bearing system according to claim 3 in which the length of the contact portion of the bearing unit housing exceeds the distance along the axis between the part of the contact portion of the bearing unit nearest the first side of the barrier and the part of the contact portion of a replacement bearing unit nearest the second side of the barrier.

5. A bearing system according to claim 3 in which the bearing system includes one motor, one or more drive shafts connecting the motor to the bearing unit and one or more drive shafts connecting the bearing unit to the equipment to be driven.

6. A bearing system according to Claim 3 in which the bearing unit housing is provided with an aperture extending from the first to the second side of the barrier which is of circular cross section and is of constant radius throughout at least the mid 90% of its length.

7. A bearing system according to claim 3 in which an increased radius is provided for a portion of the bearing unit housing closest to the first and/or second sides of the barrier.

8. A bearing system according to claim 3 in which the bearing unit has a constant radius throughout at least 80% of its axial length and the bearing unit has a reduced radius towards the ends nearest the first and/or second sides of the barrier.

9. A bearing system according to any preceding claim 3 in which the drive shaft extending through the bearing unit is provided with a male portion at one end, and a female portion at the other end.

10. A method of replacing a bearing unit in a bearing system, the bearing system including a barrier, a bearing unit housing and a bearing unit for conveying a drive through the barrier, the bearing unit housing defining an opening through the barrier extending between first and second sides of the barrier, the bearing unit housing extending along an axis, the bearing unit housing including a contact portion extending parallel to the axis which contacts a contact portion of the bearing unit extending parallel to the axis, the method comprising:
disconnecting the bearing unit in the bearing system from the drive to and from the bearing unit;
introducing a replacement bearing unit into abutment with the bearing unit and advancing the replacement bearing unit into the bearing unit housing from the first side of the barrier and displacing the bearing unit towards the second side of the barrier;
during displacement, contact being maintained between at least a part of a contact portion of the bearing unit and at least a part of a contact portion of the bearing unit housing until contact occurs between at least a part of a contact portion of the replacement bearing unit and at least a part of a contact portion of the bearing unit; and
removing the bearing unit from the bearing unit housing on the second side of the barrier and connecting the bearing unit to the drives to and from the bearing unit.

11. A method according to claim 10 in which the bearing unit is disconnected from the drives to the bearing unit by removing the flexible coupling and/or drive shaft linking the flexible coupling to the bearing unit and/or the drive shaft linking the flexible coupling to the motor and/or by moving the motor.

12. A method according to claim 10 in which the drive from the bearing unit is be disconnected by removing the drive shaft adjacent to the drive shaft of the bearing unit, potentially together with the coupling or a portion thereof connecting those drive shafts together and potentially and alternatively together with the removal of at least part of the coupling connecting that drive shaft to the subsequent drive shaft of the bearing system.

13. A method according to claim 10 in which the replacement bearing unit is introduced along the axis of the bearing unit housing and the part of the drive shaft of the replacement bearing unit closest to the first side of the barrier engages with the part of the bearing unit furthest from the second side of the barrier.

14. A system according to claim 1 in which the bearing system includes one motor, one or more drive shafts connecting the motor to the bearing unit and one or more drive shafts connecting the bearing unit to the equipment to be driven.

15. A system according to claim 1 in which the bearing unit housing is provided with an aperture extending from the first to the second side of the barrier which is of circular cross section and is of constant radius throughout at least the mid 90% of its length.

16. A system according to claim 1 in which an increased radius is provided for a portion of the bearing unit housing closest to the first and/or second sides of the barrier.

17. A system according to claim 1 in which the bearing unit has a constant radius throughout at least 80% of its axial length and the bearing unit has a reduced radius towards the ends nearest the first and/or second sides of the barrier.

18. A system according to claim 1 in which the drive shaft extending through the bearing unit is provided with a male portion at one end, and a female portion at the other end.
